(19) United States
(12) Patent Application Publication
(10) Pub. No.: US 2023/0409959 A1
(43) Pub. Date: Dec. 21, 2023

(54) GROUPED AGGREGATION IN FEDERATED LEARNING

(71) Applicant: INTERNATIONAL BUSINESS MACHINES CORPORATION, ARMONK, NY (US)

(72) Inventors: Ali Anwar, San Jose, CA (US); Yi Zhou, San Jose, CA (US); NATHALIE BARACALDO ANGEL, San Jose, CA (US); Runhua Xu, Pittsburgh, PA (US); YUYA JEREMY ONG, San Jose, CA (US); Annie K Abay, San Jose, CA (US); Heiko H. Ludwig, San Francisco, CA (US); Gegi Thomas, Danbury, CT (US); Jayaram Kallapalayam Radhakrishnan, Pleasantville, NY (US); Laura Wynter, Singapore (SG)

(21) Appl. No.: 17/807,871

(22) Filed: Jun. 21, 2022

(51) Int. Cl. G06N 20/00; H04L 67/10

(52) U.S. Cl. CPC G06N 20/00; H04L 67/10

(57) ABSTRACT

According to one embodiment, a method, computer system, and computer program product for grouped federated learning is provided. The embodiment may include initializing a plurality of aggregation groups including a plurality of parties and a plurality of local aggregators. The embodiment may also include submitting a query to a first party from the plurality of parties. The embodiment may further include submitting an initial response to the query from the first party or a second party from the plurality of parties to a first local aggregator from the plurality of local aggregators. The embodiment may also include submitting a final response from the first local aggregator or a second local aggregator from the plurality of local aggregators to a global aggregator. The embodiment may further include building a machine learning model based on the final response.

### BACKGROUND

The present invention relates generally to the field of computing, and more particularly to machine learning.

Machine learning is a field of computing that deals with the process of training a computer algorithm, model, or artificial intelligence to “learn” to perform particular tasks. Machine learning may be used as part of a system of artificial intelligence, natural language processing, speech recognition, computer vision, or predictive analytics. Machine learning may further include techniques such as statistical modeling, deep learning, federated learning, generative adversarial networks, and neural networks.

### SUMMARY

According to one embodiment, a method, computer system, and computer program product for grouped federated learning is provided. The embodiment may include initializing a plurality of aggregation groups including a plurality of parties and a plurality of local aggregators. The embodiment may also include submitting a query to a first party from the plurality of parties. The embodiment may further include submitting an initial response to the query from the first party or a second party from the plurality of parties to a first local aggregator from the plurality of local aggregators. The embodiment may also include submitting a final response from the first local aggregator or a second local aggregator from the plurality of local aggregators to a global aggregator. The embodiment may further include building a machine learning model based on the final response.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for grouped aggregation in federated learning according to at least one embodiment.

FIG. 3 illustrates an exemplary tree of a global aggregator, local aggregators, and parties according to at least one embodiment.

FIG. 4 is a block diagram of internal and external components of computers and servers depicted in FIG. 1 according to at least one embodiment.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to machine learning. The following described exemplary embodiments provide a system, method, and program product to, among other things, perform federated learning on multiple groups of parties across multiple levels of aggregators. Therefore, the present embodiment has the capacity to improve the technical field of machine learning by allowing a federated machine learning system to divide federated learning tasks according to groups.

As previously described, machine learning is a field of computing that deals with the process of training a computer algorithm, model, or artificial intelligence to “learn” to perform particular tasks. Machine learning may be used as part of a system of Artificial Intelligence (AI), natural language processing, speech recognition, computer vision, or predictive analytics. Machine learning may further include techniques such as statistical modeling, deep learning, federated learning, generative adversarial networks, and neural networks.

Federated learning is a process whereby separate parties with their own data sources can create combined machine learning solutions while keeping their own data private. Particularly, federated learning may involve an aggregator that sends queries to several parties with private data, and then builds a machine learning model from the responses of each party without ever receiving the private data. However, existing solutions for federated learning run into issues involving privacy and technical capacity at scale.

Specifically, current solutions may involve many small, different parties interacting with one large aggregator. This creates large issues with memory, network bandwidth, and CPU capacity at the point of aggregation. It further creates privacy risks if, for example, the federated learning system provides metadata about party devices to the aggregator. As such, it may be advantageous to, among other things, divide federated learning aggregation into groups and levels, dividing bandwidth and allowing each group at each level to structure its machine learning process in different ways, enabling each group to manage privacy and other policies independently, and greatly improving throughput.

According to at least one embodiment, a federated learning network may initialize aggregators and groups of identified parties to participated in grouped federated learning. The parties may, for example, be grouped by type of party, geographic distance, or relationship with an aggregator. Each party may then collect data to use in responding to queries. The aggregators may, at each level, submit a query to the lower level, and the parties and lower aggregators may each respond to the higher level, ultimately to a global aggregator. Then, each aggregator may build one or more machine learning models in light of the aggregated responses.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for grouped aggregation in federated learning.

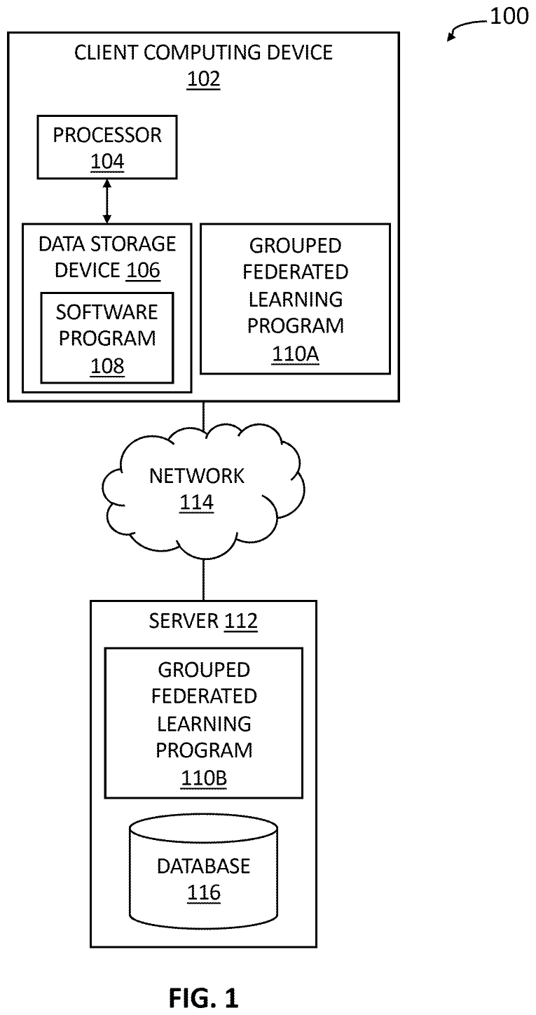

Referring to FIG. 1, an exemplary networked computer environment 100 is depicted, according to at least one embodiment. The networked computer environment 100 may include client computing device 102, and a server 112, interconnected via a communication network 114. According to at least one implementation, the networked computer environment 100 may include a plurality of client computing devices 102, and servers 112, of which only one of each is shown for illustrative brevity. Additionally, in one or more embodiments, the client computing device 102 and server 112 may each individually host a grouped federated learning program 110A, 110B. In one or more other embodiments, the grouped federated learning program 110A, 110B may be partially hosted on both client computing device 102 and server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

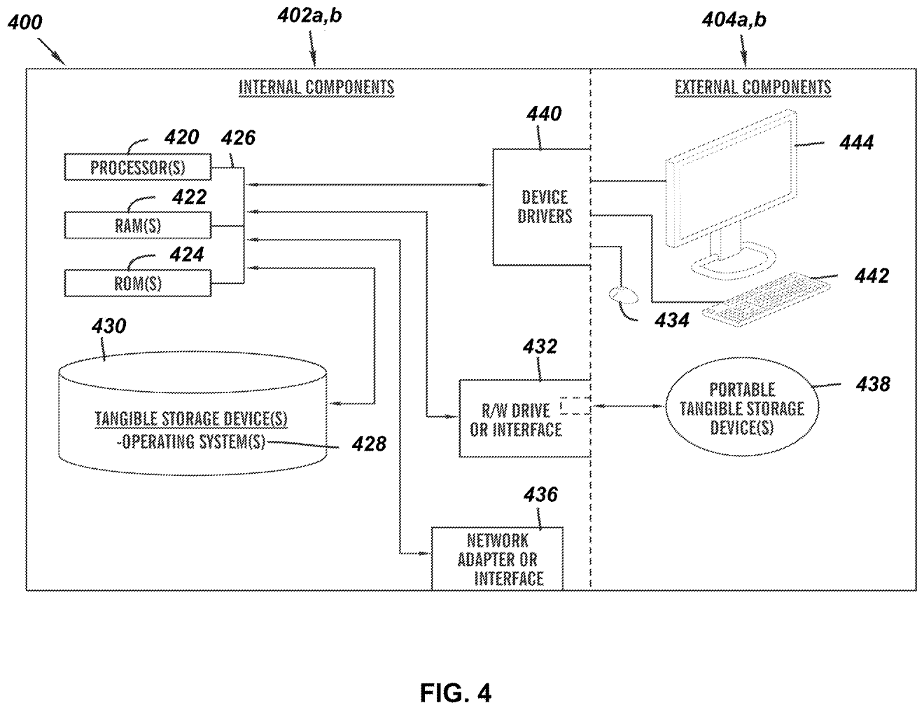

Client computing device 102 may include a processor 104 and a data storage device 106 that is enabled to host and run a software program 108 and a grouped federated learning program 110A and communicate with the server 112 via the communication network 114, in accordance with one embodiment of the invention. In one or more other embodiments, client computing device 102 may be, for example, a mobile device, a personal digital assistant, a vehicle, a netbook, a laptop computer, a tablet computer, a desktop computer, a television, or any type of computing device capable of running a program and accessing a network. As previously described, one client computing device 102 is depicted in FIG. 1 for illustrative purposes, however, any number of client computing devices 102 may be utilized. As will be discussed with reference to FIG. 4, the client computing device 102 may include internal components 402a and external components 404a, respectively.

The server computer 112 may be a mainframe, a laptop computer, netbook computer, personal computer (PC), a desktop computer, a television, or any programmable electronic device or any network of programmable electronic devices capable of hosting and running a grouped federated learning program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

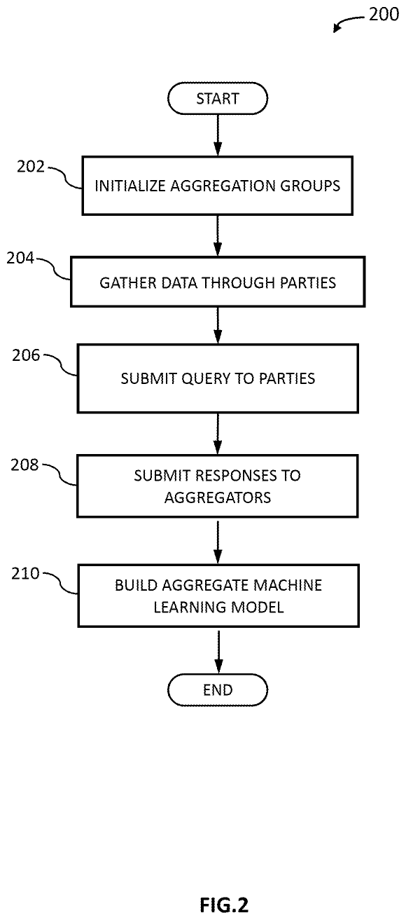

According to the present embodiment, the grouped federated learning program 110A, 110B may be capable of allowing aggregators and groups of identified parties to participate in grouped federated learning. The parties may, for example, be grouped by type of party, geographic distance, or relationship with an aggregator. The parties may then gather data for use in response to queries. The global aggregator and local aggregators may further submit queries to local aggregators and parties. The parties and local aggregators may then return responses to local and global aggregators. The grouped federated learning program 110A, 110B may further build one or more aggregated machine learning models in light of the responses. The grouped federated learning method is explained in further detail below with respect to FIG. 2.

Referring now to FIG. 2, an operational flowchart illustrating a process for grouped federated learning 200 is depicted according to at least one embodiment. At 202, the grouped federated learning program 110A, 110B initializes aggregation groups. Initialization may include identifying parties, grouping the parties into groups, selecting one or more aggregators for each party, or determining aggregation policies. A party may be a person, company, or device that has a source of data that may be used in grouped federated learning.

In at least one embodiment, initialization may include a process of identifying parties. The grouped federated learning program 110A, 110B may identify parties by a selection process through, for example, local aggregators. For example, where a group corresponds to a company, a local aggregator may be a server owned by the company, and the parties may be devices owned by that company which the company determines should participate in grouped federated learning. Alternatively, parties may identify themselves, initiating their own participation in federated learning through an opt-in process. For example, a user may agree to terms and conditions upon purchasing a vehicle, install a smartphone application and enable a grouped federated learning feature with regards to photography editing, or engage in a commercial services agreement with a grouped federated learning services provider.

In at least one embodiment, parties may be grouped into predetermined groups for aggregation. For example, if a party is a device owned by a company, a group may correspond to the company. Alternatively, a group may correspond to an industry, such as healthcare or software development. Alternatively, a group may correspond to a type of device, such as a group of vehicles or a group of mobile phones.

In an alternate embodiment, parties may be grouped and regrouped dynamically. For example, parties may be grouped based on location, such as a grouping based on the nearest aggregator. As an alternate example, parties may be grouped based on resource usage. More specifically, parties that correspond to high resource usage may be placed in groups corresponding to aggregators with the most bandwidth available. As yet another example, groups may be selected based on peak data usage times to balance load so as to minimize wasted resources.

In at least one embodiment, parties may be grouped, statically or dynamically, based on a complex combination of multiple factors. For example, parties may be grouped according to a weighted balance of physical location, a variety of bandwidth expectations, and device type. Alternatively, parties may be grouped by a process of AI, including use of statistical modeling, deep learning, federated learning, a generative adversarial network, or a neural network.

In at least one embodiment, parties may be grouped in a mapping of precisely one group per party. In an alternate embodiment, parties may participate in any other discrete number of groups. For example, a vehicle owned by a company may be grouped into one group corresponding to vehicles, another group corresponding to the company that owns the vehicle, and another group corresponding to the geographic region in which the vehicle is present. Alternatively, a party may not be grouped into any groups. A party without a group may be regrouped dynamically over time, or may participate in federated learning by some alternative, default, or backup procedure. For example, parties without groups may work with a default aggregator, or work directly with a global aggregator.

In another embodiment, the grouped federated learning program 110A, 110B may select an aggregator for a party, or select parties for an aggregator, by the same procedures by which parties are identified or grouped. For example, if an aggregator corresponds to a group, a party may select an aggregator corresponding to the group of which it is a member. Alternatively, if parties are grouped by a type of device, parties may select aggregators based on region. A party may select more than one aggregator.

In at least one embodiment, the grouped federated learning program 110A, 110B may determine aggregation policies. Aggregation policies may be determined globally, relative to a group, relative to an aggregator, or individually at a party level. Aggregation policies may include, for example, privacy policies, metadata policies, or a method for building a machine learning model.

In yet another embodiment, the grouped federated learning program 110A, 110B may initialize more than two levels of aggregators. The grouped federated learning program 110A, 110B may further group aggregators into groups. For example, a company may own one “level two” aggregator and ten “level three” aggregators. Parties owned by the company may be grouped corresponding to a level three aggregator, level three aggregators may be grouped by a company as corresponding to that company's level two aggregator, and level two aggregators corresponding to several companies may each interact directly with global aggregators. Alternatively, aggregators may not exist in discrete levels, but may interact with other aggregators freely; for example, local aggregator B may submit responses to aggregator A, and local aggregator C may submit responses to both aggregator A and local aggregator B.

A group may include only parties, only aggregators, or a mix of parties and aggregators. In at least one embodiment, a group may further include other devices or other entities. For example, a group may include all mobile devices owned by a company, regardless of whether the device participates in grouped federated learning or not.

In at least one embodiment, the grouped federated learning program 110A, 110B may initialize new aggregators, parties, or groups, or reinitialize with regards to existing aggregators, parties, or groups.

Then, at 204, the grouped federated learning program 110A, 110B gathers data at a party level. Gathering data may include generating data, capturing data, or receiving data from an external source. Gathering data may be performed using a wide variety of known means, including capturing user input, utilizing sensors on a client computing device, or accessing an Application Programming Interface (API) that provides data.

In at least one embodiment, a party may capture user input. For example, if a party is a mobile device, the party may ask users to describe nearby weather data. Alternatively, a party may access data from a sensor, for example, a camera set up to measure cloud cover, a rain meter, or a barometer. As yet another alternative, a party may access an API, such as a weather API from a weather data services provider.

In another embodiment, a party may gather data in advance of any particular need. For example, a party may gather market data daily and store that data locally for use in the future. Alternatively, a party may generate data by processing data gathered from other sources. For example, if a party gathers a photograph, the party may generate projected measurements for an object in the photograph using computer vision and other known methods.

In yet another embodiment, data may be gathered in response to a query. For example, if a query asks whether or not a given image contains a bicycle, the grouped federated learning program 110A, 110B may ask a user whether or not that image contains a bicycle, may collect known images of bicycles from previously tagged image data, or engage in image recognition to determine a location of a bicycle in an image. Alternatively, if a query asks for information regarding market conditions, the grouped federated learning program 110A, 110B may access a market data API for data that may be useful in responding to the query.

Then, at 206, the grouped federated learning program 110A, 110B submits a query to one or more parties. A query may include any question or request for which a response might be useful, either directly or in training a machine learning model.

In at least one embodiment, a query may be submitted to a party by a local aggregator. Alternatively, a query may be submitted to one or more parties from a global aggregator, another party, a user, or an external source.

In a further embodiment, a query may be submitted to a local aggregator by a global aggregator. Alternatively, if there are more than two levels of aggregator, a query may be submitted from any aggregator to the aggregator one level below. Queries may be submitted down each level to one or more aggregators until the query reaches a party.

In at least one embodiment, a query may include a question or request for which a user desires a response. For example, a query may ask what the likelihood of rain is on a given date. Alternatively, a query may include a question or request for which a response may be useful in training a machine learning model. For example, a query may ask whether or not a given photograph contains a representation of a traffic light.

Then, at 208, the grouped federated learning program 110A, 110B submits responses to aggregators. Responses may be submitted from any device that receives a request at 206, including a party or a local aggregator.

In at least one embodiment, a response contains only a response to the query and no other data. Alternatively, a response may contain other data, such as metadata about the response, the query, the party, or the aggregator, but not the gathered data. In an alternative embodiment, a response may include a portion of the gathered data.

In at least one embodiment, a party may determine a response to a query locally, based on gathered data. Alternatively, a party may use a process that involves the assistance of an external device, such as a server, to determine a response to a query. Determining a response to a query may be conducted by machine learning, statistical analysis, direct repetition of relevant data, or any other method responsive to the query.

In at least one embodiment, a party or local aggregator may submit a response to a local aggregator selected at 202, including, for example, a local aggregator associated with the party, or corresponding to a group that the party is a member of, or may submit a response to a global aggregator.

In an alternate embodiment, a party or local aggregator may submit responses to more than one local aggregator or global aggregator. A party may send all responses to multiple aggregators, or split responses so that no one aggregator receives all responses from that party. A party may, for example, submit each response to two local aggregators selected at random to enhance privacy or ensure redundancy.

In an alternate embodiment, a party or local aggregator may submit a response to another entity not involved in grouped federated learning.

In another embodiment, a local aggregator may submit a response from a party to a higher-level aggregator. In an alternate embodiment, a local aggregator may determine a response based on responses that have been submitted to the local aggregator.

In at least one embodiment, a local aggregator may form a response through a process of aggregation. Aggregation may include forming, for example, a cumulative response, an average response, a weighted averaged response, a robust complex response, a partial response, a series of responses submitted by parties or lower-level aggregators, or a process of machine learning. A process of machine learning may include statistical modeling, deep learning, a separate instance of federated learning, a generative adversarial network, or a neural network.

For example, aggregation by a cumulative response or series of responses to a query about whether or not an image contains a representation of a bicycle may tally the number of responses that assert that the party does and does not contain a representation of a bicycle. Alternatively, an average response may provide an averaged confidence score from confidence scores in each response. More specifically, if three responses suggest that a photograph does, does, and does not contain a bicycle with 80, 70, and 70 percent confidence, the aggregate response may be that the image is 60% likely to contain a bicycle. Alternatively, a robust complex response may assign a confidence score to each response based on the past success of the responding party, remove responses with a confidence score below 80%, and provide a tally of responses with confidence scores above 80%.

In an alternate embodiment, aggregation may include a process of processing responses, submitting a modified query, and aggregating new responses. For example, if a query asks whether the sentiment of a given sentence is happy, sad, angry, or neutral, and responses state that it is 33% likely to be happy, 10% likely to be sad, 28% likely to be angry, and 29% likely to be neutral, a modified query may ask whether the sentiment of the sentence is happy, angry, or neutral. If a new response indicates that a sentence is 34% likely to be happy, 31% likely to be angry, and 35% likely to be neutral, another modified query may ask whether a statement is happy or neutral. If another new response states that a statement is 58% likely to be happy and 42% neutral, the aggregated response may be aggregated using other means described above.

In yet another embodiment, if a query asks for a sentiment of each sentence in a series of one hundred sentences and a sentiment for the whole passage, a partial response may, for example, provide a projected sentiment for only the sentences for which the party or local aggregator can reach a response with more than 68% confidence.

In a further embodiment, a local aggregator may select an aggregation method according to an aggregation policy determined at 202.

In at least one embodiment, a local or global aggregator may arrive at a solution through a process of aggregation. Forming an aggregate solution may be performed using substantially the same methods used to form an aggregate response. An aggregate solution based on non-conclusory responses may arrive at a conclusory or non-conclusory solution. For example, if responses indicate that an image is 60% likely to contain a representation of a bicycle, a solution may state that the image contains a representation of a bicycle, or that the image is 60% likely to contain a representation of a bicycle. An aggregate solution may be a full or partial solution.

Then, at 210, the grouped federated learning program 110A, 110B builds one or more machine learning models. The grouped federated learning program 110A, 110B may build one combined machine learning model, one machine learning model for each group, for each aggregator, or for each party, or a combination of the above. Alternatively, grouped federated learning program 110A, 110B may build aggregators for each group, aggregator, or party that requests its own machine learning model.

Building a machine learning model may be performed through a process of aggregation. For example, a machine learning model may train based on a series of responses with equal weight, or based on a series of responses weighted according to the number of parties that participated in each response. For example, if Group A contains 422 parties, and group B contains 653 parties, Global Aggregator C may weigh a response from Local Aggregator A with a weight of 422 and weigh a response from Local Aggregator B with a weight of 653.

In at least one embodiment, the grouped federated learning program 110A, 110B builds one machine learning model at the global level. The grouped federated learning program 110A, 110B may further provide the global machine learning model to local aggregators or parties.

In an alternate embodiment, the grouped federated learning program 110A, 110B builds machine learning models for multiple local aggregators, groups, or parties. For example, if, at 202, parties determine that each group should receive a machine learning model based on all of the responses received by the global aggregator, but built according to a method determined by the group. Alternatively, the machine learning model may be based on only the responses for that group, but built using a predetermined method.

In at least one embodiment, a machine learning model may be built gradually over time. Alternatively, a machine learning model may be built only after a sufficient number of responses are received from all top-level local aggregators.

In at least one embodiment, the machine learning model may be built based on the responses according to known methods of building machine learning models. Known methods of building machine learning models may include the use of statistical modeling, deep learning, a separate instance of federated learning, a generative adversarial network, or a neural network.

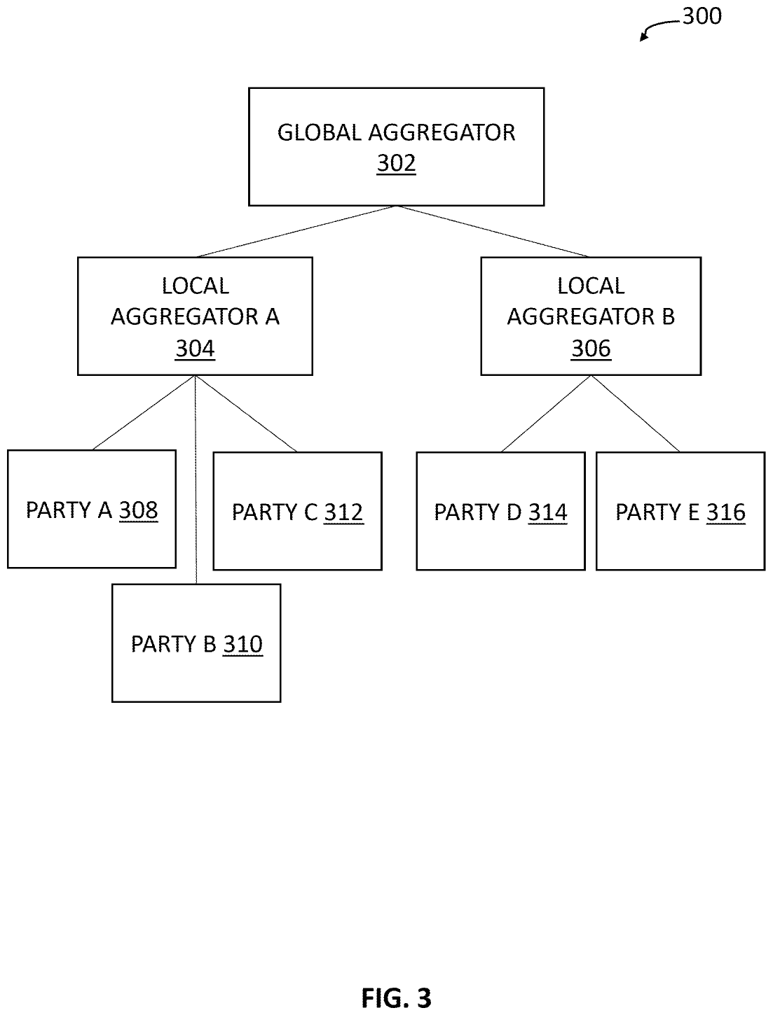

FIG. 3 illustrates an exemplary tree of a global aggregator, local aggregators, and parties according to at least one embodiment. A group may be composed of all the parties in a tree under a local aggregator.

In at least one embodiment, a global aggregator 302 may submit a query to local aggregators 304 and 306, which in turn submit the query to parties 308, 310, 312, 314, 316. In a further embodiment, parties 308, 310, 312, 314, 316 submit responses to local aggregators 304, which in turn submit responses to a global aggregator 302. More specifically, local aggregator A 304 may submit the query to party A 308, party B 310, and party C 312, and local aggregator B 306 may submit the query to party D 314 and party E 316. Each party may submit a response to the aggregator that submitted a query to the respective party.

In an alternate embodiment, there may be more than one level of local aggregators. For example, global aggregator 302 may submit a query to a third local aggregator C, which may submit queries to fourth local aggregator D and fifth local aggregator E, which each submit queries to parties.

It may be appreciated that FIG. 2 and FIG. 3 provide only illustrations of one implementation and do not imply any limitations with regard to how different embodiments may be implemented. Many modifications to the depicted environments may be made based on design and implementation requirements.

FIG. 4 is a block diagram 400 of internal and external components of the client computing device 102. the server 112, and the networking device 120 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102, the server 112, and the networking device 120 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the grouped federated learning program 110A in the client computing device 102 and the grouped federated learning program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the grouped federated learning program 110A, 110B, can be stored on one or more of the respective portable computer-readable tangible storage devices 438, read via the respective RAY drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the grouped federated learning program 110A in the client computing device 102 and the grouped federated learning program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the grouped federated learning program 110A in the client computing device 102 and the grouped federated learning program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

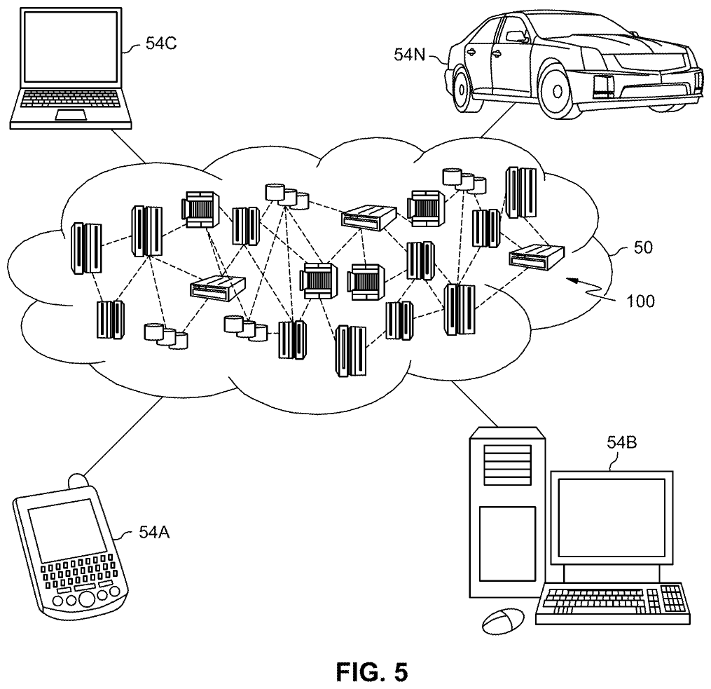

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

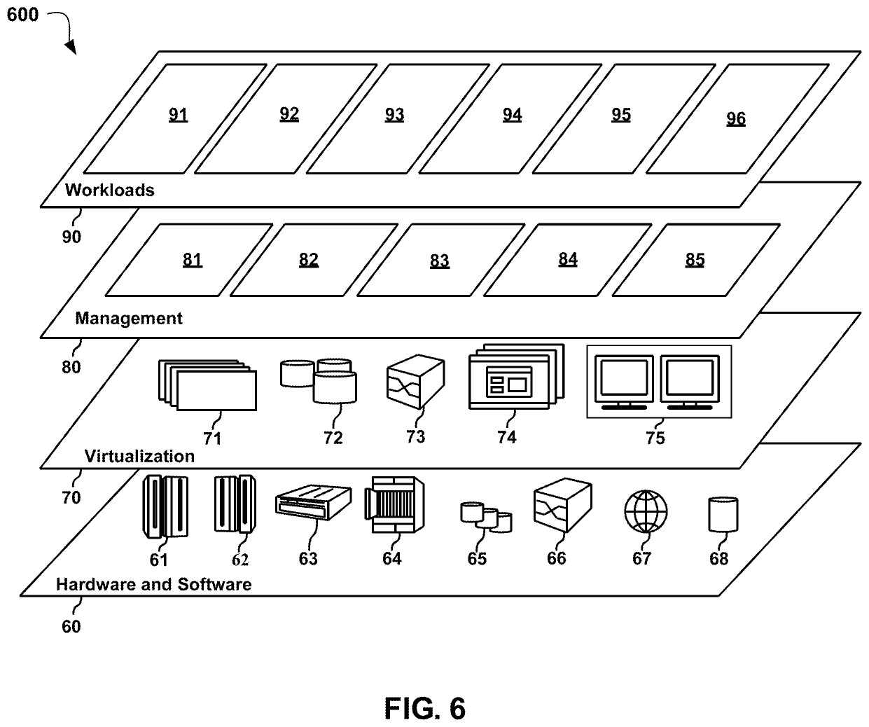

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and grouped federated learning 96. Grouped federated learning 96 may relate to federated learning by groups and levels.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
initializing a plurality of aggregation groups including a plurality of parties and a plurality of local aggregators;
submitting a query to a first party from the plurality of parties;
submitting an initial response to the query from the first party or a second party from the plurality of parties to a first local aggregator from the plurality of local aggregators;
submitting a final response from the first local aggregator or a second local aggregator from the plurality of local aggregators to a global aggregator; and
building a machine learning model based on the final response.

2. The method of claim 1, further comprising:
submitting an intermediary response from the first local aggregator or a first intermediary aggregator to the second local aggregator, the first intermediary aggregator, or a second intermediary local aggregator.

3. The method of claim 1, wherein each local aggregator from the plurality of local aggregators selects an aggregation method, and wherein the final response is determined using the aggregation method.

4. The method of claim 1, wherein the plurality of aggregation groups each correspond to a physical location.

5. The method of claim 1, wherein a party from the plurality of parties can be removed from a first aggregation group from the plurality of aggregation groups or placed in a second aggregation group from a plurality of aggregation groups after the initializing of the plurality of application groups.

6. The method of claim 1, wherein the submitting further comprises:
submitting a plurality of initial responses to more than one local aggregator from the plurality of local aggregators.

7. The method of claim 6, wherein each party that submits a plurality of responses submits responses to different local aggregators so each local aggregator receives an incomplete subset of the plurality of responses.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
initializing a plurality of aggregation groups including a plurality of parties and a plurality of local aggregators;
initializing a plurality of aggregation groups including a plurality of parties and a plurality of local aggregators;
submitting a query to a first party from the plurality of parties;
submitting an initial response to the query from the first party or a second party from the plurality of parties to a first local aggregator from the plurality of local aggregators;
submitting a final response from the first local aggregator or a second local aggregator from the plurality of local aggregators to a global aggregator; and
building a machine learning model based on the final response.

9. The computer system of claim 8, further comprising:
submitting an intermediary response from the first local aggregator or a first intermediary aggregator to the second local aggregator, the first intermediary aggregator, or a second intermediary local aggregator.

10. The computer system of claim 8, wherein each local aggregator from the plurality of local aggregators selects an aggregation method, and wherein the final response is determined using the aggregation method.

11. The computer system of claim 8, wherein the plurality of aggregation groups each correspond to a physical location.

12. The computer system of claim 8, wherein a party from the plurality of parties can be removed from a first aggregation group from the plurality of aggregation groups or placed in a second aggregation group from a plurality of aggregation groups after the initializing of the plurality of application groups.

13. The computer system of claim 8, wherein the submitting further comprises:
submitting a plurality of initial responses to more than one local aggregator from the plurality of local aggregators.

14. The computer system of claim 13, wherein each party that submits a plurality of responses submits responses to different local aggregators so each local aggregator receives an incomplete subset of the plurality of responses.

15. A computer program product, the computer program product comprising:
one or more computer-readable tangible storage medium and program instructions stored on at least one of the one or more tangible storage medium, the program instructions executable by a processor capable of performing a method, the method comprising:
initializing a plurality of aggregation groups including a plurality of parties and a plurality of local aggregators;
initializing a plurality of aggregation groups including a plurality of parties and a plurality of local aggregators;
submitting a query to a first party from the plurality of parties;
submitting an initial response to the query from the first party or a second party from the plurality of parties to a first local aggregator from the plurality of local aggregators;
submitting a final response from the first local aggregator or a second local aggregator from the plurality of local aggregators to a global aggregator; and
building a machine learning model based on the final response.

16. The computer program product of claim 15, further comprising:
submitting an intermediary response from the first local aggregator or a first intermediary aggregator to the second local aggregator, the first intermediary aggregator, or a second intermediary local aggregator.

17. The computer program product of claim 15, wherein each local aggregator from the plurality of local aggregators selects an aggregation method, and wherein the final response is determined using the aggregation method.

18. The computer program product of claim 15, wherein the plurality of aggregation groups each correspond to a physical location.

19. The computer program product of claim 15, wherein a party from the plurality of parties can be removed from a first aggregation group from the plurality of aggregation groups or placed in a second aggregation group from a plurality of aggregation groups after the initializing of the plurality of application groups.

20. The computer program product of claim 15, wherein the submitting further comprises:
submitting a plurality of initial responses to more than one local aggregator from the plurality of local aggregators.
